(19) United States
(12) Patent Application Publication
(10) Pub. No.: US 2008/0035098 A1
(43) Pub. Date: Feb. 14, 2008

(54) Portable handheld work apparatus

(75) Inventors: Johannes Menzel, Wernau (DE); Marc Schmid, Oppenweiler (DE); Wolfgang Weissert, Winnenden (DE); Eberhard Bohnaker, Leutenbach (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 11/882,350

(22) Filed: Aug. 1, 2007

(30) Foreign Application Priority Data
Aug. 9, 2006 (DE) 10 2006 037 201.8

(51) Int. Cl. F16M 1/026

(52) U.S. Cl. 123/195 A

(57) ABSTRACT

A portable handheld work apparatus has an internal combustion engine (5) having a cylinder (8) and a crankcase (13). The cylinder (8) has an opening (19) for exhaust gases whereat an exhaust-gas muffler (14) is mounted. The exhaust-gas muffler (14) is mounted on the cylinder (8) at least at one attachment location (40, 41) and at least a further attachment location (42) on the internal combustion engine (5). A reduced weight of the work apparatus and a low mechanical load of the exhaust-gas muffler (14) can be achieved when the exhaust-gas muffler is fixed at at least one of the attachment locations (42) via a connection which permits a limited relative movement between the exhaust-gas muffler (14) and the internal combustion engine (5) in at least one direction.

### CROSS REFERENCE TO RELATED APPLICATION

This application claims priority of German patent application no. 10 2006 037 201.8, filed Aug. 9, 2006, the entire content of which is incorporated herein by reference.

### BACKGROUND OF THE INVENTION

It is known to use an internal combustion engine for driving a work tool in a work apparatus with the engine having an exhaust-gas muffler for the exhaust gases of the engine. Japanese patent publication JP 6-248939 discloses mounting an exhaust-gas muffler on the cylinder as well as on the crankcase of the work apparatus. The attachment locations on the cylinder and the crankcase usually are comparatively far from each other. It is also known to attach the engine to a further attachment part on the cylinder.

Vibrations are generated during operation of the internal combustion engine. These lead to the situation that the exhaust-gas muffler tilts about the attachment locations usually arranged in the region of the outlet of the cylinder. This tilting leads to intense mechanical loads of the exhaust-gas muffler and the additional attachment location, especially, on the crankcase. In known exhaust-gas mufflers, reinforcement sheet metal parts are mounted in the muffler in order to take up the mechanical loading and reduce the deformation of the exhaust-gas muffler. To achieve an adequate stability of the exhaust-gas muffler, sheet metal parts having comparatively high metal thickness are used for the exhaust-gas muffler. This leads to increased weight of the exhaust-gas muffler and therefore to an increased weight of the entire work apparatus.

### SUMMARY OF THE INVENTION

It is an object of the invention to provide a portable handheld work apparatus of the kind described above which has a reduced weight and a stable configuration.

The portable handheld work apparatus of the invention includes: an internal combustion engine having a cylinder and a crankcase connected to the cylinder; the cylinder having an opening through which exhaust gases are discharged; an exhaust-gas muffler for receiving the exhaust gases; the exhaust-gas muffler being attached to the cylinder at a first location and being attached to the engine at a second location; and, connecting means disposed at one of the first and second locations for permitting a limited relative movement between the exhaust-gas muffler and the internal combustion engine in at least one direction.

The limited relative movability between the exhaust-gas muffler and the internal combustion engine at at least one attachment location, especially at the crankcase, allows a tilting of the exhaust-gas muffler within pregiven limits. In this way, the stresses in the exhaust-gas muffler are considerably reduced during operation. Reinforcement elements such as reinforcement sheet metal parts or the like are not needed. The exhaust-gas muffler can be configured as a light weight muffler. For this purpose, the exhaust-gas muffler can, for example, be made up of sheet metal parts which have a low sheet metal thickness. The service life of the exhaust-gas muffler is increased because of the reduced mechanical load.

Advantageously, the exhaust-gas muffler is attached to the crankcase of the internal combustion engine at at least one attachment location. In this way, a good support of the exhaust-gas muffler is obtained. The exhaust-gas muffler is advantageously attached to the crankcase via a connection which permits a limited relative movement in at least one direction between the exhaust-gas muffler and the crankcase. In this way, the exhaust-gas muffler can tilt about the attachment location on the cylinder within pregiven limits.

The connection advantageously permits a limited relative movement in all spatial directions. In this way, stresses in all spatial directions are reduced or avoided. The connection especially effects a thermal decoupling between the exhaust-gas muffler and the crankcase. In this way, excessive heating of the crankcase is prevented in a simple manner. The connection advantageously includes at least one elastic and/or damping element. An elastic element permits a relative movement between exhaust-gas muffler and crankcase and simultaneously ensures a connection of the exhaust-gas muffler to the crankcase. The damping characteristics of the element reduce the transmission of vibrations or oscillations between the exhaust-gas muffler and the crankcase so that the vibration development of the work apparatus is reduced overall.

The element is advantageously a metal cushion element. Metal cushion elements of this kind comprise pressed wire fabric. Metal cushion elements have elastic and damping characteristics and are very resistant to temperature and have poor thermal conductive characteristics because of the porous configuration so that largely a thermal decoupling results. A metal cushion element of this kind has a low weight and small structural size and is therefore well suited for use in a portable handheld work apparatus.

The element is advantageously pretensioned. A pretensioning of the element ensures that the exhaust-gas muffler is reliably held on the crankcase. It is practical to mount at least one rigid spacer in the effective direction of the pretensioning force. The rigid spacer ensures, in a simple manner, a defined pretensioning force.

A good decoupling of exhaust-gas muffler and-crankcase can be achieved when two metal cushion components are provided which are mounted in the effective direction of the pretensioning force seen at both sides of an attachment section of the exhaust-gas muffler. The metal cushion elements have elastic and damping characteristics only under pressure load. For this reason, a good decoupling is achieved with two metal cushion elements in the effective direction of the pretension force and in the opposite direction. The connection of the exhaust-gas muffler to the internal combustion engine advantageously includes at least one attachment element and this connection permits a limited relative movement in at least one direction. The exhaust-gas muffler especially has a distance or spacing to the attachment element perpendicular to the effective direction of the attachment element and supports itself in this direction at a metal cushion element. In this way, a relative movability between the exhaust-gas muffler and the crankcase as well as a thermal and mechanical decoupling is realized also perpendicular to the effective direction of the attachment element.

A simple configuration of the connection can be achieved in that the metal cushion element is configured as a metal cushion ring having an opening and the attachment element projects through the opening. The connection especially includes a bushing which is mounted in the opening and through which the attachment element is passed. The bushing advantageously simultaneously defines a spacer for adjusting a defined pretension force.

The exhaust-gas muffler has two housing half shells which are connected to each other at an edge and the exhaust-gas muffler is connected to the crankcase at the edge. In this way, a simple configuration of the exhaust-gas muffler is provided. The housing half shells are advantageously formed from deep-drawn sheet metal parts. The thickness of the sheet metal amounts especially to 0.5 mm or less. So a low sheet metal thickness for the housing half shells is adequate because of the possible relative movement between the exhaust-gas muffler and the crankcase. A reduced weight of the exhaust-gas muffler is achieved when the exhaust-gas muffler has a reinforcement element at most in the region of the attachment locations to the cylinder. No further reinforcement elements are needed because of the possible relative movement between the exhaust-gas muffler and the crankcase. Even reinforcement elements in the region of the attachment locations to the cylinder are not needed so that the exhaust-gas muffler has no reinforcement element.

### BRIEF DESCRIPTION OF THE DRAWINGS

The invention will now be described with reference to the drawings wherein:

FIG. 1 is a schematic section view of a work apparatus according to the invention;

FIG. 2 shows a detail section view taken along line II-II in FIG. 1;

FIG. 3 is a schematic section view of an exhaust-gas muffler which is attached to a cylinder and a crankcase;

FIG. 4 is an enlarged view of the attachment location of the exhaust-gas muffler on the crankcase; and, FIG. 5 shows a variation of the attachment location shown in FIG. 4.

### DESCRIPTION OF THE PREFERRED EMBODIMENTS OF THE INVENTION

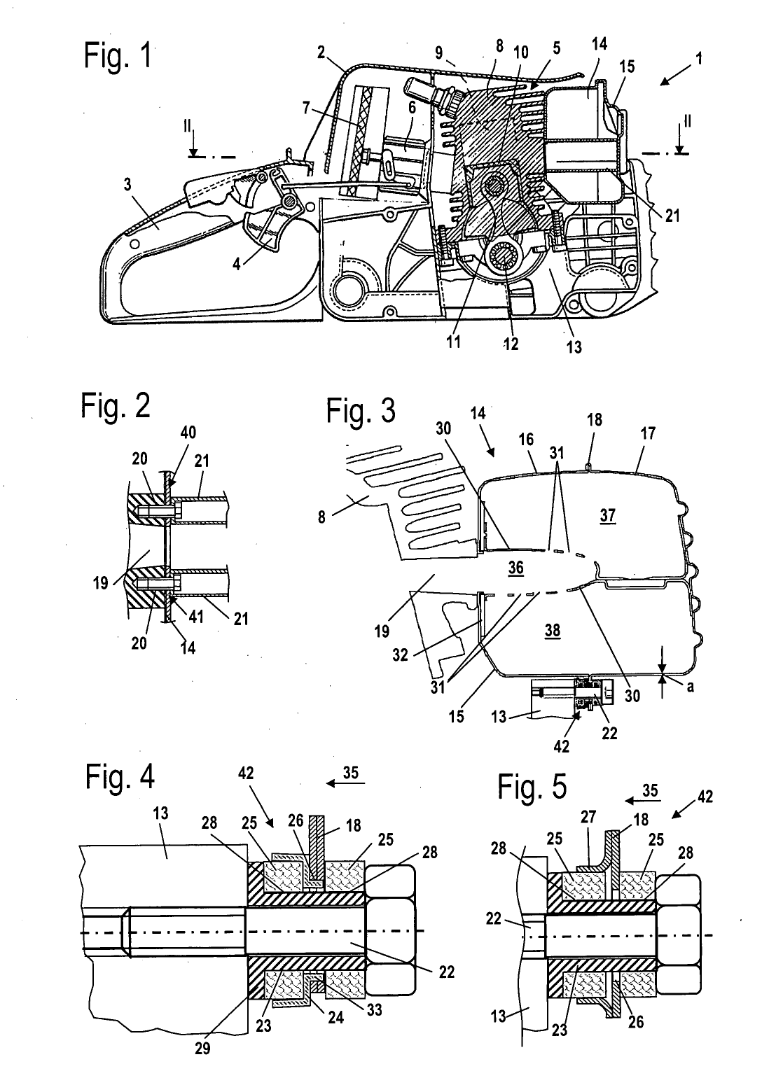

The work apparatus shown in FIG. 1 is a motor-driven chain saw 1. The motor-driven chain saw 1 has a housing 2 to which a rearward handle 3 is attached. The rearward handle 3 has a throttle lever 4 for the operation of an internal combustion engine 5 mounted in the housing 2. The internal combustion engine 5 is configured as a single-cylinder two-stroke engine and includes an air filter 7 which is connected to the internal combustion engine 5 via a carburetor 6. The intake channel configured in the carburetor 6 opens into a crankcase 13 of the engine 5. The engine 5 has a cylinder 8 wherein a combustion chamber 9 is formed. A piston 10 is mounted for reciprocal movement in the cylinder 8. The piston 10 drives a crankshaft 12 via a connecting rod 11 and the crankshaft 12 is rotatably journalled in the crankcase 13. The crankshaft 12 drives a work tool (not shown in FIG. 1), namely, a saw chain. An exhaust-gas muffler 14 is mounted on the internal combustion engine 5 and has a housing 15. The exhaust-gas muffler 14 has attachment bushings 21 which project through the housing 15 of the exhaust-gas muffler 14.

As shown in the section view of FIG. 2, the cylinder 8 has an outlet 19 from the combustion chamber 9 whereat the exhaust-gas muffler 14 is attached. The attachment bushings 21 end at respective sides of the outlet 19. The heads of attachment screws 20 lie against the base of the attachment sleeves 21, respectively. The attachment screws 20 threadably engage the cylinder 8 on both sides of the outlet 19. The attachment screws 20 define attachment locations 40 and 41 whereat the exhaust-,gas muffler 14 is fixedly connected to the cylinder 8.

As shown in FIG. 3, a reinforcement or stiffening sheet metal part 32 is mounted next to the outlet 19 on the housing 15 of the exhaust-gas muffler 14. The reinforcing sheet metal part reinforces the housing 15 in the region of the attachment locations 40 and 41.

As shown in FIG. 3, the housing 15 of the exhaust-gas muffler 14 is made up of two housing half shells 16 and 17 which are connected to each other at an edge 18. The half shell 17 is bent-over flange connected about the half shell 16 at the edge 18. In this way, a gas-tight connection between the two housing half shells 16 and 17 is provided. A seal can furthermore be mounted on the edge 18. Two partition walls 30 are arranged in the housing 15 of the exhaust-gas muffler 14. These partition walls 30 subdivide the interior space of the exhaust-gas muffler 14 into a chamber 36 disposed at the outlet 19 as well as two chambers 37 and 38. From the chamber 36, the exhaust gas reaches the two chambers 37 and 38 via respective passthrough openings 31 in the partition walls 30.

At the edge 18, an attachment location 42 is configured at the side of the exhaust-gas muffler 14 facing toward the crankcase 13. The exhaust-gas muffler 14 is attached to the crankcase 13 at the attachment location 42. The attachment location 42 is so configured that the exhaust-gas muffler 14 can move at the attachment location 42 relative to the crankcase 13. An attachment screw 22 is provided as an attachment element and the exhaust-gas muffler 14 is attached to the crankcase 13 with this attachment screw. The attachment screw 22 limits the possible relative movement between the exhaust-gas muffler 14 and the crankcase 13. The housing half shells 16 and 17 and the partition walls 30 have a sheet metal thickness (a) which amounts to 0.5 mm or less. Except for the reinforcing sheet metal part 32, no further reinforcement elements are provided on the exhaust-gas muffler 14. Stiffeners such as sheet metal parts or the like are understood as stiffening elements which satisfy no additional function in the exhaust-gas muffler 14 except reinforcement. Reinforcements of this kind are usually mounted on function sheet metal parts of the exhaust-gas muffler 14 in order to reinforce the same.

The attachment location 42 is shown enlarged in FIG. 4. The attachment screw 22 passes through a bushing 23. The bushing 23 lies with a collar 29 on the crankcase 13. Two metal cushion rings 25 are mounted at the outer periphery of the bushing 28 and a section of the edge 18 of the exhaust-gas muffler 14 is arranged therebetween. The edge 18 has an opening 26 through which the bushing 23 and the attachment screw 22 project. The metal cushion rings 25 have respective center openings 28 through which the bushing 23 extends. The diameter of the openings 28 corresponds approximately to the outer diameter of the bushing 23 or is slightly smaller so that a tight seat of the metal cushion rings 25 on the bushing 23 results. The metal cushion ring 25, which is mounted between the edge 18 and the crankcase 13, is enclosed by a sleeve 24 around its periphery. The sleeve 24 is supported on the periphery and a side surface of a metal cushion ring 25 and has a sleeve section 33 which projects into the interior of the opening 26 of the edge 18. The sleeve section 33 is at a spacing to the bushing 23. The edge 18 is supported via the edge 33 of the bushing 24 on the periphery of the metal cushion ring 25. In this way, the exhaust-gas muffler 14 is decoupled from the crankcase 13 in the longitudinal direction (that is, in the effective direction of the attachment screw 22) as well as also perpendicularly to this longitudinal direction.

With one end, the bushing 23 lies against the head of the attachment screw 22 and, with its other end, against the crankcase 13. The bushing 23 is rigidly configured and fixes a defined spacing between the screw head and the crankcase 13. The length of the bushing 23 is so selected that the metal cushion rings 25 are pretensioned by a pregiven distance in the longitudinal direction of the attachment screw 22 when the screw head of the attachment screw 22 lies against the bushing 23. The pretension force then works in an effective direction which extends parallelly to the longitudinal direction of the attachment screw 22.

In the embodiment of the attachment element 42 shown in FIG. 5, the function of the bushing 24 is assumed by the edge 18 itself. The housing half shell 16 is bent over to a collar 27 in the region of the opening 26 of the edge 18. The collar 27 defines an annular section which lies against the outer periphery of a metal cushion ring 25 and so supports the exhaust-gas muffler 14 perpendicular to the effective direction 35 of the pretension force at the metal cushion ring 25.

The metal cushion rings 25 are made of pressed metal wire. Advantageously, stainless steel wire fabric is provided. The metal cushion rings 25 have damping as well as elastic and thermal insulating characteristics. In lieu of the metal cushion rings 25, also other elements can be provided which permit a limited relative movement between the exhaust-gas muffler 14 and the crankcase 13.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
an internal combustion engine having a cylinder and a crankcase connected to said cylinder;
said cylinder having an opening through which exhaust gases are discharged;
an exhaust-gas muffler for receiving said exhaust gases;
said exhaust-gas muffler being attached to said cylinder at a first location and being attached to said engine at a second location; and,
connecting means disposed at one of said first and second locations for permitting a limited relative movement between said exhaust-gas muffler and said internal combustion engine in at least one direction.

2. The portable handheld work apparatus of claim 1, wherein said exhaust-gas muffler is connected to said crankcase at said second location.

3. The portable handheld work apparatus of claim 2, said connecting means being disposed at said second location.

4. The portable handheld work apparatus of claim 1, wherein said connecting means permits a limited relative movement between said exhaust-gas muffler and said crankcase in all spatial directions.

5. The portable handheld work apparatus of claim 1, wherein said connecting means effects a thermal decoupling between said exhaust-gas muffler and said crankcase.

6. The portable handheld work apparatus of claim 1, wherein said connecting means comprises an elastic and/or damping element.

7. The portable handheld work apparatus of claim 6, wherein said element is a-metal cushion element.

8. The portable handheld work apparatus of claim 6, wherein said element is pretensioned.

9. The portable handheld work apparatus of claim 8, wherein the pretensioning of said element causes a pretension force acting in an effective direction; and, said connecting means further comprises a rigid spacer arranged in said direction.

10. The portable handheld work apparatus of claim 1, wherein said exhaust-gas muffler has a mounting location whereat said exhaust-gas muffler is attached to said engine; said connecting means comprises two elastic and/or damping metal cushion elements and pretension means for pretensioning said metal cushion elements to produce a pretension force acting in an effective direction; and, said metal cushion elements are disposed on respective sides of said mounting location viewed in said effective direction of said pretension force.

11. The portable handheld work apparatus of claim 1, wherein said connecting means comprises at least one attachment element.

12. The portable handheld work apparatus of claim 11, wherein said attachment element defines an operating direction in which said attachment element is effective in performing its function; said exhaust-gas muffler is disposed in spaced relationship to said attachment element perpendicular to said operating direction; and, said connecting means further comprises a metal cushion element disposed so as to cause said exhaust-gas muffler to be supported thereon in said operating direction.

13. The portable handheld work apparatus of claim 12, wherein said metal cushion element is a metal cushion ring defining a passthrough opening; and, said attachment element projects through said passthrough opening.

14. The portable handheld work apparatus of claim 13, wherein said connecting means further comprises a bushing arranged in said passthrough opening and said attachment element also passes through said bushing.

15. The portable handheld work apparatus of claim 1, wherein said exhaust-gas muffler has two housing half shells conjointly defining an edge whereat said housing half shells are joined to each other.

16. The portable handheld work apparatus of claim 15, wherein said exhaust-gas muffler is connected to said crankcase at said edge.

17. The portable handheld work apparatus of claim 16, wherein said two housing half shells are formed from deep-drawn sheet metal.

18. The portable handheld work apparatus of claim 17, wherein said sheet metal has a thickness (a) of 0.5 mm or less.

19. The portable handheld work apparatus of claim 3, said exhaust-gas muffler including a reinforcement element, at most, in the region of said first location.
